(19) United States
(12) Patent Application Publication
(10) Pub. No.: US 2025/0111042 A1
(43) Pub. Date: Apr. 3, 2025

(54) SYSTEM AND METHOD FOR GENERATING DATA MODELS SECURE FROM MALFEASANT MANIPULATION FOR USE IN PREDICTIVE MODELING

(71) Applicant: BANK OF AMERICA CORPORATION, Charlotte, NC (US)

(72) Inventors: Sakshi Bakshi, New Delhi (IN); Sudha Ganapathy, Chennai (IN); Durga Prasad Kutthumolu, Hyderabad (IN); Pushkar Taneja, Hyderabad (IN)

(73) Assignee: BANK OF AMERICA CORPORATION, Charlotte, NC (US)

(21) Appl. No.: 18/376,298

(22) Filed: Oct. 3, 2023

(51) Int. Cl. G06F 21/55

(52) U.S. Cl. CPC G06F 21/55

(57) ABSTRACT

Embodiments of the present invention provide a system for generating data models secure from malfeasant manipulation for use in predictive modeling. The system is configured for retrieving training data associated with predictive modeling from a data source, processing the training data retrieved from the data source, transmitting the training data to a local linear model to generate a predictive output, retrieving historical data from the data source, transmitting the predictive output from the local linear model and the historical data retrieved from the data source to a Huber loss estimator module, validating, via the Huber loss estimator module, the predictive output received from the local linear model based on the historical data retrieved from the data source, and determining, via the Huber loss estimator module, if the training data has been manipulated by a malfeasant actor based on validating the one or more data points associated with the predictive output.

### BACKGROUND

There exists a need for a system for generating data models secure from malfeasant manipulation for use in predictive modeling.

### BRIEF SUMMARY

Embodiments of the present invention address the above needs and/or achieve other advantages by providing apparatuses (e.g., a system, computer program product and/or other devices) and methods for generating data models secure from malfeasant manipulation for use in predictive modeling. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention retrieve training data associated with predictive modeling from a data source, processes the training data retrieved from the data source, transmits the training data to a local linear model to generate a predictive output, retrieves historical data from the data source, transmits the predictive output from the local linear model and the historical data retrieved from the data source to a Huber loss estimator module, validates, via the Huber loss estimator module, the predictive output received from the local linear model based on the historical data retrieved from the data source, and determines, via the Huber loss estimator module, if the training data has been manipulated by a malfeasant actor based on validating the one or more data points associated with the predictive output.

In some embodiments, the present invention validates, via the Huber loss estimator, the predictive output based on comparing one or more data points associated with the predictive output with one or more patterns associated with the historical data.

In some embodiments, the present invention determines that the training data has been manipulated based on determining, via the Huber loss estimator module, a deviation in the predictive output based on comparing the one or more data points associated with the predictive output with the one or more patterns associated with the historical data.

In some embodiments, the present invention extracts real-time external data associated with the predictive modeling from the data source, transmits the real-time external data through a pseudo free model to generate a pseudo free output, analyzes the pseudo free output generated by the pseudo free model and the deviation determined by the Huber loss estimator module, and revalidates that the training data has been manipulated based on analyzing the pseudo free output generated by the pseudo free model and the deviation determined by the Huber loss estimator module.

In some embodiments, the present invention in response to determining that the training data has been manipulated, performing at least one of automatically altering the training data, performing machine unlearning associated with the training data on the local linear model to generate a data model secure from malfeasant manipulation, isolating the training data and transmitting a notification to a user, and automatically performing analysis on the training data and generating a report associated with the analysis.

In some embodiments, the present invention receives actual data in real-time associated with the predictive modeling and runs the actual data through the data model secure from malfeasant manipulation to generate a real-time predictive modeling output.

In some embodiments, the pseudo free model is the data model secure from malfeasant manipulation at a previous instance.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for generating data models secure from malfeasant manipulation for use in predictive modeling, in accordance with an embodiment of the invention;

FIG. 2 provides a block diagram illustrating the entity system 200 of FIG. 1, in accordance with an embodiment of the invention;

FIG. 3 provides a block diagram illustrating a secure data models generation system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for generating data models secure from malfeasant manipulation for use in predictive modeling, in accordance with an embodiment of the invention;

FIG. 6 provides a process flow for validating malfeasant manipulation of training data provided to the data models, in accordance with an embodiment of the invention; and

FIG. 7 provides a block diagram illustrating the process of generating data models secure from malfeasant manipulation for use in predictive modeling, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the term “entity” may include any organization that processes requests from multiple channels. Furthermore, embodiments of the present invention use the term “user.” It will be appreciated by someone with ordinary skill in the art that the user may be an employee of the entity. In an embodiment of the present invention, the entity may be a financial institution. In some embodiments of the present invention, the entity may be a non-financial institution. In some embodiments, the entity may be any organization that utilizes data models for performing one or more organizational activities. In some embodiments, a user may be an employee (e.g., application developer, analyst, human resources specialist, and/or the like) of the entity. In some embodiments, the user may be a customer of the entity. In some embodiments, the user may be a potential customer of the entity.

Typically, machine learning models are training continuously using training data at periodic intervals. However, the training data provided to the machine learning models is prone to malfeasant manipulation by unauthorized users, thereby reducing the accuracy of the machine learning models that are used in predictive modeling. As such, there exists a need for a system to determine if the training data that is being used to train the machine learning models continuously is manipulated by unauthorized users and taking one or more actions to generate data models that are secure from malfeasant manipulation.

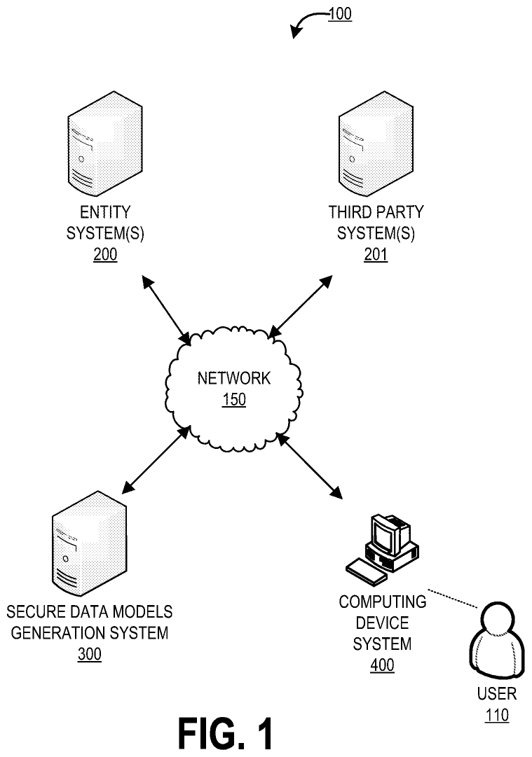

FIG. 1 provides a block diagram illustrating a system environment 100 for generating data models secure from malfeasant manipulation for use in predictive modeling, in accordance with an embodiment of the invention. As illustrated in FIG. 1, the environment 100 includes a secure data models generation system 300, entity system 200, one or more third party systems 201, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees of an entity associated with the entity system 200.

The entity system(s) 200 may be any system owned or otherwise controlled by an entity to support or perform one or more process steps described herein. In some embodiments, the entity is a financial institution. In some embodiments, the entity is a non-financial institution. The one or more third party systems 201 may be external data sources that provide external data associated with predictive modeling.

The secure data models generation system 300 is a system of the present invention for performing one or more process steps described herein. In some embodiments, the secure data models generation system 300 may be an independent system. In some embodiments, the secure data models generation system 300 may be a part of the entity system 200.

The secure data models generation system 300, the entity system 200, the computing device system 400, and/or the third party systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the secure data models generation system 300 is configured to communicate information or instructions with the entity system 200, the computing device system 400, and/or the third party systems 201 across the network 150.

The computing device system 400 may be a computing device of the user 110. In general, the computing device system 400 communicates with the user 110 via a user interface of the computing device system 400, and in turn is configured to communicate information or instructions with the secure data models generation system 300, entity system 200, and/or the third party systems 201 across the network 150.

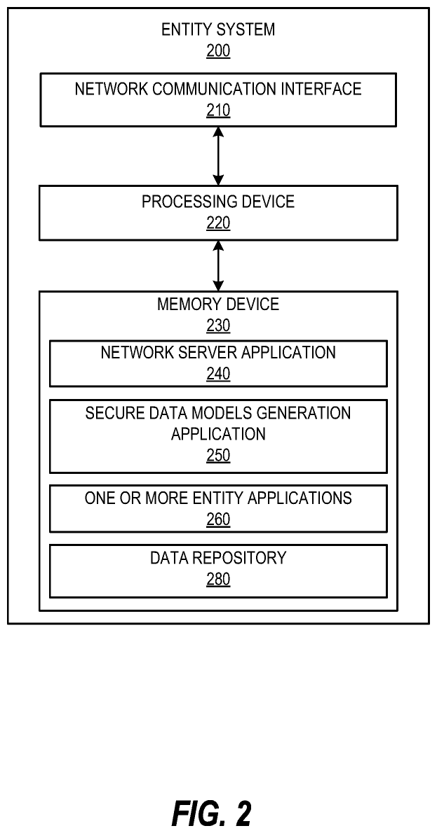

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In some embodiments, the entity system 200 may be operated by any entity that utilizes machine learning models to perform one or more organizational activities. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a secure data models generation application 250, one or more entity applications 260, and a data repository 280. The computer-executable program code of the network server application 240, the secure data models generation application 250, and the one or more entity applications 260 to perform certain logic, data-extraction, and data-storing functions of the entity system 200 described herein, as well as communication functions of the entity system 200.

The network server application 240, the secure data models generation application 250, and the one or more entity applications 260 are configured to store data in the data repository 280 or to use the data stored in the data repository 280 when communicating through the network communication interface 210 with the secure data models generation system 300, and the computing device system 400 to perform one or more process steps described herein. In some embodiments, the entity system 200 may receive instructions from the secure data models generation system 300 via the secure data models generation application 250 to perform certain operations. The secure data models generation application 250 may be provided by the secure data models generation system 300.

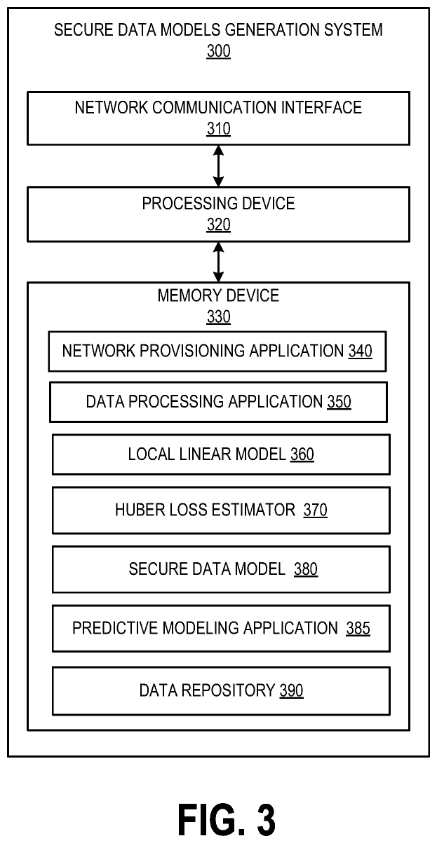

FIG. 3 provides a block diagram illustrating the secure data models generation system 300 in greater detail, in accordance with embodiments of the invention. As illustrated in FIG. 3, in one embodiment of the invention, the secure data models generation system 300 includes one or more processing devices 320 operatively coupled to a network communication interface 310 and a memory device 330. In certain embodiments, the secure data models generation system 300 is operated by a first entity, such as a financial institution, while in other embodiments, the secure data models generation system 300 is operated by an entity other than a financial institution. In some embodiments, the secure data models generation system 300 is owned or operated by the entity of the entity system 200. In some embodiments, the secure data models generation system 300 may be an independent system. In alternate embodiments, the secure data models generation system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the secure data models generation system 300 described herein. For example, in one embodiment of the secure data models generation system 300, the memory device 330 includes, but is not limited to, a network provisioning application 340, a data processing application 350, a local linear model 360, a Huber loss estimator 370, a secure data model 380, a predictive modeling application 385, and a data repository 390 comprising data processed or accessed by one or more applications in the memory device 330. The computer-executable program code of the network provisioning application 340, the data processing application 350, the local linear model 360, the Huber loss estimator 370, the secure data model 380, and the predictive modeling application 385 may instruct the processing device 320 to perform certain logic, data-processing, and data-storing functions of the secure data models generation system 300 described herein, as well as communication functions of the secure data models generation system 300.

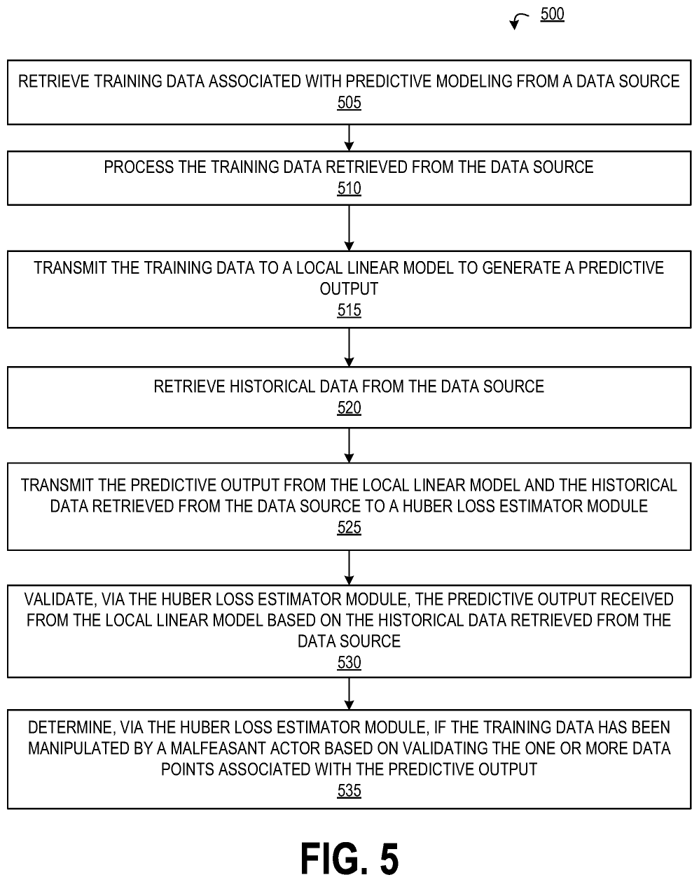

The network provisioning application 340, the data processing application 350, the local linear model 360, the Huber loss estimator 370, the secure data model 380, and the predictive modeling application 385 are configured to invoke or use the data in the data repository 390 when communicating through the network communication interface 310 with the entity system 200, and the computing device system 400. In some embodiments, the network provisioning application 340, the data processing application 350, the local linear model 360, the Huber loss estimator 370, the secure data model 380, and the predictive modeling application 385 may store the data extracted or received from the entity system 200 and the computing device system 400 in the data repository 390. In some embodiments, the network provisioning application 340, the data processing application 350, the local linear model 360, the Huber loss estimator 370, the secure data model 380, and the predictive modeling application 385 may be a part of a single application. One or more processes performed by the data processing application 350, the local linear model 360, the Huber loss estimator 370, the secure data model 380, and the predictive modeling application 385 are described in FIGS. 5 through 7.

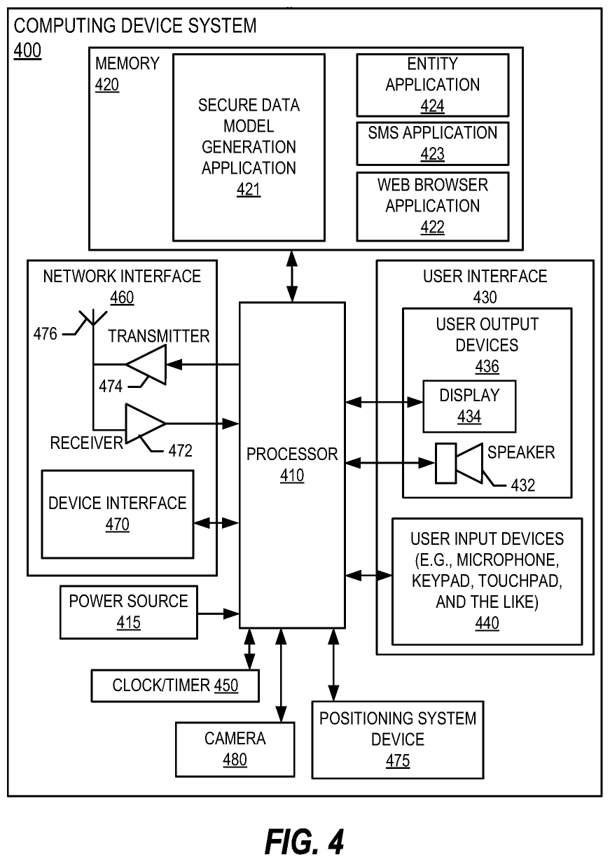

FIG. 4 provides a block diagram illustrating a computing device system 400 of FIG. 1 in more detail, in accordance with embodiments of the invention. However, it should be understood that the computing device system 400 is merely illustrative of one type of computing device system that may benefit from, employ, or otherwise be involved with embodiments of the present invention and, therefore, should not be taken to limit the scope of embodiments of the present invention. The computing devices may include any one of portable digital assistants (PDAs), pagers, mobile televisions, mobile phone, entertainment devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110 may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a secure data models generation application 421, an entity application 424, or the like. These applications also typically instructions to a graphical user interface (GUI) on the display 430 that allows the user 110 to interact with the entity system 200, the secure data models generation system 300, and/or other devices or systems. The memory 420 of the computing device system 400 may comprise a Short Message Service (SMS) application 423 configured to send, receive, and store data, information, communications, alerts, and the like via the wireless network 150.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 provides a process flow for generating data models secure from malfeasant manipulation for use in predictive modeling, in accordance with an embodiment of the invention. As shown in block 505, the system retrieves training data associated with predictive modeling from a data source. In some embodiments, the data source may be an internal data source associated with an entity (e.g., the entity system 200, the computing device system 400, or the like). In some embodiments, the data source may be an external data source (e.g., third party systems 201, or the like). The training data may be specific to the predictive modeling process using data models described in the present invention. For example, if the predictive modeling is associated with predicting stocks, the training data may comprise information associated with an organization earnings, price history, price to earnings ratio, financial ratios, moving averages, economic indicators, news, trading volumes, volatility, technical indicators, and/or the like. In some embodiments, the training data may be updated in the data source (e.g., by the entity system 200, the secure data models generation system 300, the user 110, or the like).

As shown in block 510, the system processes the training data retrieved from the data source. Processing the training data may comprise restructuring, sorting, normalizing, deleting, changing format of the data, and/or the like. As shown in block 515, the system transmits the training data to a local linear model to generate a predictive output. The local linear model is a statistical model that combines advantages of linear regression and robust regression techniques. The local linear model may be trained continuously at periodic intervals (e.g., hourly, daily, weekly, monthly, quarterly, yearly, or the like). After receiving the training data, the local linear model may train itself and provide an output associated with the predictive modeling process based on the training using the training data retrieved in block 505 and the historical training performed at all of the previous instances. In some embodiments, the local linear model may be data model that is generated by the system of the present invention at a previous instance, where the data model is secure from malfeasant manipulation.

As shown in block 520, the system retrieves historical data from the data source. The system also retrieves historical data associated with the predictive modeling process stored in a data repository (e.g., data repository 390). The historical data may comprise all previous historical training data used to train the data models used for the predictive modeling process. Continuing with the previous example, if the predictive modeling is associated with predicting stocks, the historical data may comprise information associated with an organization historical earnings, price history, historical price to earnings ratio, historical financial ratios, historical moving averages, historical economic indicators, historical news, historical trading volumes, historical volatility, historical technical indicators, and/or the like.

As shown in block 525, the system transmits the predictive output from the local linear model and the historical data retrieved from the data source to a Huber loss estimator module. Huber loss estimator module comprises Huber loss Function for handling regression tasks to handle outliers, which uses a combination of linear and quadratic losses that balance the trade-off between the linear and quadratic losses, thereby resulting in a better fit to the data. Huber loss function has an ability to transition smoothly between the quadratic and absolute loss functions. The Huber loss function makes the data models that are generated by the present invention less sensitive to extreme values in data that is being provided to the data models for training or for predictive modeling purposes. The Huber loss function has continuous derivatives at all points for optimizing using gradient based methods. The Huber loss function has a tuning parameter, called the “delta” parameter that allows for adjustment of the Huber loss function to fit the data more accurately. The Huber loss provides a good compromise between the robustness of the absolute error loss and the efficiency of the Mean Squared Error (MSE) loss.

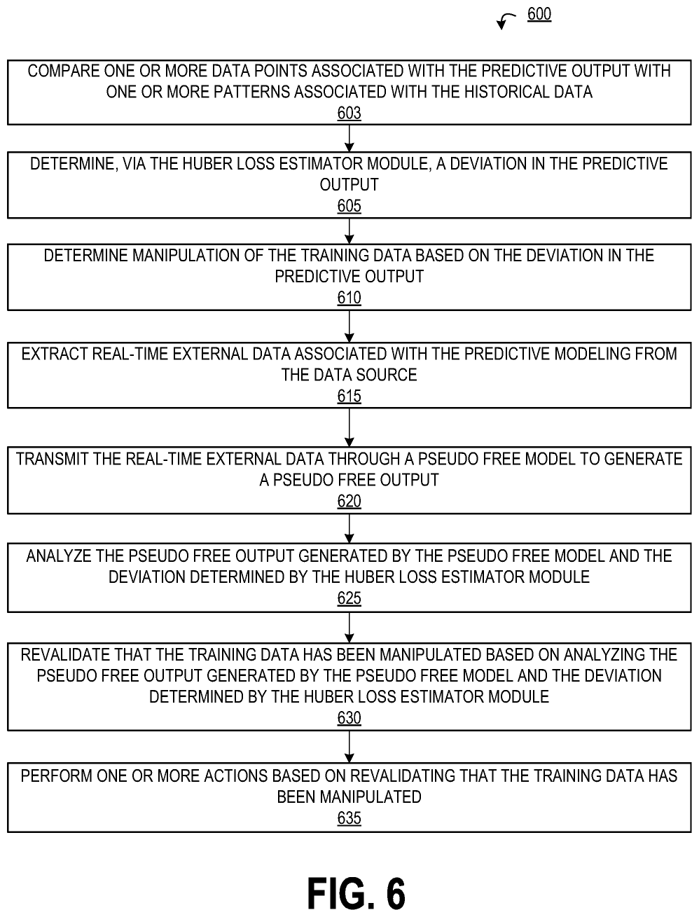

As shown in block 530, the system validates, via the Huber loss estimator module, the predictive output received from the local linear model based on the historical data retrieved from the data source. As shown in block 535, the system determines, via the Huber loss estimator module, if the training data has been manipulated by a malfeasant actor based on validating the one or more data points associated with the predictive output. The process of validating the predictive output and determining that the training data has been manipulated is described in detail in FIG. 6.

FIG. 6 provides a process flow for validating malfeasant manipulation of training data provided to the data models, in accordance with an embodiment of the invention. As shown in block 603, the system compares one or more data points associated with the predictive output with one or more patterns associated with the historical data. Validating the predictive output as described in block 530 of FIG. 5 comprises comparing the one or more data points associated with the predictive output with the one or more patterns associated with the historical data. Continuing with the previous example, the system compares the historical predictive modeling outputs generated using the historical data with the predictive output generated by the local linear model in block 515.

As shown in block 605, the system determines, via the Huber loss estimator module, a deviation in the predictive output. The system may determine that a deviation exists in at least one of the one or more data points associated with the predictive output when compared with patterns associated with the historical predictive modeling outputs generated using the historical data. Continuing with the previous example, the system may identify that previously predicted forecast associated with pricing of stock ‘A’ of a company is $100 and the current forecast generated by the local linear model after training using the training data is $2 and may determine a deviation. It should be understood that the examples provided herein are for explanatory purposes only and in no way delineate the scope of the present invention.

As shown in block 610, the system determines manipulation of the training data based on the deviation in the predictive output. In response to determining the deviation in block 603, the system may determine that the training data has been manipulated. For example, the system may determine that the stock price based on historical predictive outputs is $50 and the predictive output generated by the local linear model based on the training data is $0.1. The system may determine such a deviation in the stock prices as an indication that the training data provided to the local linear model is manipulated.

As shown in block 615, the system extracts real-time external data associated with the predictive modeling from the data source. The real-time external data may comprise any new developments associated with the predictive modeling process. Continuing with the previous example, the system may extract real-time market data and real-time organizational data associated with a stock that may explain the deviation determined in the previous steps.

As shown in block 620, the system transmits the real-time external data through a pseudo free model to generate a pseudo free output. As shown in block 625, the system analyzes the pseudo free output generated by the pseudo free model and the deviation determined by the Huber loss estimator module.

As shown in block 630, the system revalidates that the training data has been manipulated based on analyzing the pseudo free output generated by the pseudo free model and the deviation determined by the Huber loss estimator module. For example, the system may determine that the pseudo free output generated based on the real-time external data is not consistent with the predictive output generated by the local linear model and that the determination of the deviation is accurate and may revalidate that the training data has been manipulated. In another case, the system may determine that the pseudo free output generated based on the real-time external data is consistent with the predictive output generated by the local linear model and may determine that the training data is not manipulated. In some such instances, the training received by the local linear model using the training data is enforced and is used for performing real-time predictive modeling.

As shown in block 635, the system performs one or more actions based on revalidating that the training data has been manipulated. The one or more actions may comprise at least one of automatically altering the training data (e.g., to match the historical data), performing machine unlearning associated with the training data on the local linear model to generate a data model secure from malfeasant manipulation, isolating the training data and transmitting a notification to a user; and automatically performing analysis on the training data and generating a report associated with the analysis. In some embodiments, the local linear model, the pseudo free model may be versions of the data models that are secure malfeasant manipulations as generated based on the one or more actions taken by the system at previous instances.

The system may then receive actual data in real-time associated with the predictive modeling and may run the actual data through the data model secure from malfeasant manipulation to generate a real-time predictive modeling output.

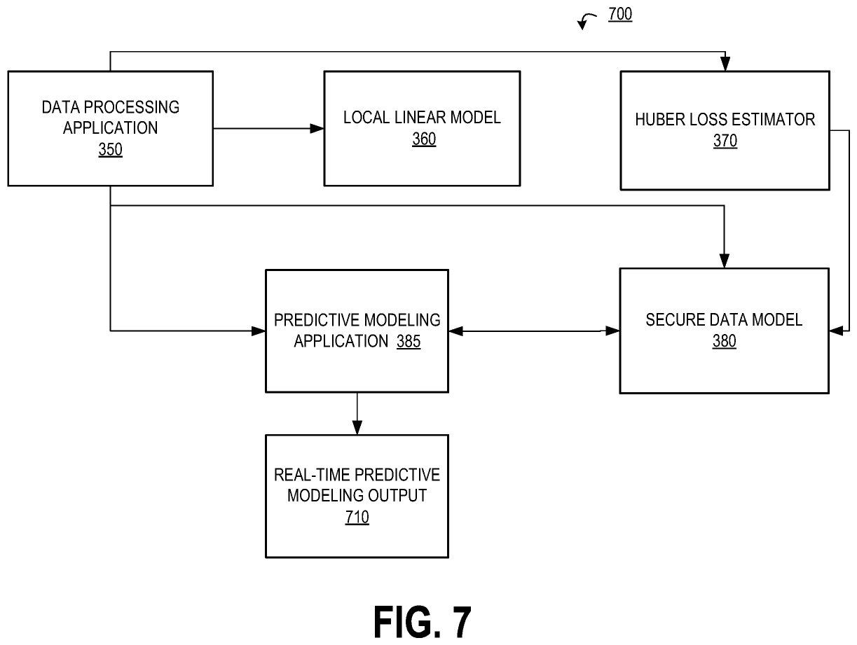

FIG. 7 provides a block diagram illustrating the process of generating data models secure from malfeasant manipulation for use in predictive modeling, in accordance with an embodiment of the invention. As shown, the data processing application 350 retrieve the training data from various data sources and processes the training data before transmitting the training data to the local linear model 360. Upon receiving the training data, the local linear model 360 generates a predictive output based on the training achieved from the training data. The predictive output is then transmitted to the Huber loss estimator 370 along with historical data that is provided by the data processing application 350. The Huber loss estimator 370 validates the predictive output generated by the local linear model to determine any manipulation associated with the training data. The output of the Huber loss estimator 370 is then transmitted to the secure data model 380 along with real-time external data that is provided by the data processing application 350. The secure data model 380 revalidates that the training model is manipulated by a malfeasant actor based on comparing the output of the Huber loss estimator 370 and the pseudo free output generated by the secure data model based on the real-time external data. Upon determination of the manipulation, one or more actions are taken by the system to at least generate an optimized model, where the optimized model is utilized by the predictive modeling application 385 to generate real-time predictive modeling outputs for actual data that is received from the data processing application 350 in real-time.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for generating data models secure from malfeasant manipulation for use in predictive modeling, comprising:
at least one processing device;
at least one memory device; and
a module stored in the at least one memory device comprising executable instructions that when executed by the at least one processing device, cause the at least one processing device to:
retrieve training data associated with predictive modeling from a data source;
process the training data retrieved from the data source;
transmit the training data to a local linear model to generate a predictive output;
retrieve historical data from the data source;
transmit the predictive output from the local linear model and the historical data retrieved from the data source to a Huber loss estimator module;
validate, via the Huber loss estimator module, the predictive output received from the local linear model based on the historical data retrieved from the data source; and
determine, via the Huber loss estimator module, if the training data has been manipulated by a malfeasant actor based on validating the one or more data points associated with the predictive output.

2. The system according to claim 1, wherein the executable instructions cause the at least one processing device to validate, via the Huber loss estimator module, the predictive output based on comparing one or more data points associated with the predictive output with one or more patterns associated with the historical data.

3. The system according to claim 2, wherein the executable instructions cause the at least one processing device to determine that the training data has been manipulated based on determining, via the Huber loss estimator module, a deviation in the predictive output based on comparing the one or more data points associated with the predictive output with the one or more patterns associated with the historical data.

4. The system according to claim 3, wherein the executable instructions cause the at least one processing device to:
extract real-time external data associated with the predictive modeling from the data source;
transmit the real-time external data through a pseudo free model to generate a pseudo free output;
analyze the pseudo free output generated by the pseudo free model and the deviation determined by the Huber loss estimator module; and
revalidate that the training data has been manipulated based on analyzing the pseudo free output generated by the pseudo free model and the deviation determined by the Huber loss estimator module.

5. The system according to claim 3, wherein the executable instructions cause the at least one processing device to in response to determining that the training data has been manipulated, performing at least one of:
automatically altering the training data;
performing machine unlearning associated with the training data on the local linear model to generate a data model secure from malfeasant manipulation;
isolating the training data and transmitting a notification to a user; and
automatically performing analysis on the training data and generating a report associated with the analysis.

6. The system according to claim 5, wherein the executable instructions cause the at least one processing device to:
receive actual data in real-time associated with the predictive modeling; and
run the actual data through the data model secure from malfeasant manipulation to generate a real-time predictive modeling output.

7. The system according to claim 6, wherein the pseudo free model is the data model secure from malfeasant manipulation at a previous instance.

8. A computer program product for generating data models secure from malfeasant manipulation for use in predictive modeling, comprising a non-transitory computer-readable storage medium having computer-executable instructions for:
retrieving training data associated with predictive modeling from a data source;
processing the training data retrieved from the data source;
transmitting the training data to a local linear model to generate a predictive output;
retrieving historical data from the data source;
transmitting the predictive output from the local linear model and the historical data retrieved from the data source to a Huber loss estimator module;
validating, via the Huber loss estimator module, the predictive output received from the local linear model based on the historical data retrieved from the data source; and
determining, via the Huber loss estimator module, if the training data has been manipulated by a malfeasant actor based on validating the one or more data points associated with the predictive output.

9. The computer program product according to claim 8, wherein the non-transitory computer-readable storage medium comprises computer-executable instructions for validating, via the Huber loss estimator module, the predictive output based on comparing one or more data points associated with the predictive output with one or more patterns associated with the historical data.

10. The computer program product according to claim 9, wherein the non-transitory computer-readable storage medium comprises computer-executable instructions for determining that the training data has been manipulated based on determining, via the Huber loss estimator module, a deviation in the predictive output based on comparing the one or more data points associated with the predictive output with the one or more patterns associated with the historical data.

11. The computer program product according to claim 10, wherein the non-transitory computer-readable storage medium comprises computer-executable instructions for:
extracting real-time external data associated with the predictive modeling from the data source;
transmitting the real-time external data through a pseudo free model to generate a pseudo free output;
analyzing the pseudo free output generated by the pseudo free model and the deviation determined by the Huber loss estimator module; and
revalidating that the training data has been manipulated based on analyzing the pseudo free output generated by the pseudo free model and the deviation determined by the Huber loss estimator module.

12. The computer program product according to claim 9, wherein the non-transitory computer-readable storage medium comprises computer-executable instructions for, in response to determining that the training data has been manipulated, performing at least one of:
automatically altering the training data;
performing machine unlearning associated with the training data on the local linear model to generate a data model secure from malfeasant manipulation;
isolating the training data and transmitting a notification to a user; and
automatically performing analysis on the training data and generating a report associated with the analysis.

13. The computer program product according to claim 12, wherein the non-transitory computer-readable storage medium comprises computer-executable instructions for:
receiving actual data in real-time associated with the predictive modeling; and
running the actual data through the data model secure from malfeasant manipulation to generate a real-time predictive modeling output.

14. The computer program product according to claim 13, wherein the pseudo free model is the data model secure from malfeasant manipulation at a previous instance.

15. A computerized method for generating data models secure from malfeasant manipulation for use in predictive modeling, the method comprising:
retrieving training data associated with predictive modeling from a data source;
processing the training data retrieved from the data source;
transmitting the training data to a local linear model to generate a predictive output;
retrieving historical data from the data source;
transmitting the predictive output from the local linear model and the historical data retrieved from the data source to a Huber loss estimator module;
validating, via the Huber loss estimator module, the predictive output received from the local linear model based on the historical data retrieved from the data source; and
determining, via the Huber loss estimator module, if the training data has been manipulated by a malfeasant actor based on validating the one or more data points associated with the predictive output.

16. The computerized method according to claim 15, wherein the method comprises validating, via the Huber loss estimator module, the predictive output based on comparing one or more data points associated with the predictive output with one or more patterns associated with the historical data.

17. The computerized method according to claim 16, wherein the method comprises determining that the training data has been manipulated based on determining, via the Huber loss estimator module, a deviation in the predictive output based on comparing the one or more data points associated with the predictive output with the one or more patterns associated with the historical data.

18. The computerized method according to claim 17, wherein the method comprises:
extracting real-time external data associated with the predictive modeling from the data source;
transmitting the real-time external data through a pseudo free model to generate a pseudo free output;
analyzing the pseudo free output generated by the pseudo free model and the deviation determined by the Huber loss estimator module; and
revalidating that the training data has been manipulated based on analyzing the pseudo free output generated by the pseudo free model and the deviation determined by the Huber loss estimator module.

19. The computerized method according to claim 17, wherein the method comprises in response to determining that the training data has been manipulated, performing at least one of:
automatically altering the training data;
performing machine unlearning associated with the training data on the local linear model to generate a data model secure from malfeasant manipulation;
isolating the training data and transmitting a notification to a user; and
automatically performing analysis on the training data and generating a report associated with the analysis.

20. The computerized method according to claim 19, wherein the method comprises:
receiving actual data in real-time associated with the predictive modeling; and
running the actual data through the data model secure from malfeasant manipulation to generate a real-time predictive modeling output.
